(19) United States
(12) Patent Application Publication
(10) Pub. No.: US 2002/0178018 A1
(43) Pub. Date: Nov. 28, 2002

(54) System and method for communicating with customers

(76) Inventors: Donald Ray Gillis, San Jose, CA (US); Gordon James Smith, Rochester, MN (US)

Correspondence Address: Dugan & Dugan, L.L.P., 18 John Street, Tarrytown, NY, 10591, US

(21) Appl. No.: 09/866,231

(22) Filed: May 25, 2001

(51) Int. Cl. G06F 17/60

(52) U.S. Cl. 705/1

(57) ABSTRACT

The arrival of a customer at a service facility is detected automatically and a communication channel is opened between a computer operated by a service provider and a portable computing device carried by the customer. The computer operated by the service provider retrieves data relating to the customer from a database and transmits to the customer's portable computing device information relevant to a service to be provided to the customer. The present invention may be applied in the context of an airline terminal to help a customer cope with a delayed or canceled flight.

### FIELD OF THE INVENTION

This invention is concerned with computer systems, and more particularly with computer systems that are programmed to automatically provide customer service.

### BACKGROUND OF THE INVENTION

It is known to provide customer service automatically via computer systems. For example, automatic voice response systems are employed to allow a customer to obtain information from a computer via telephone. It is also known to use kiosks to provide customer service functions. However, the art of computer systems has not heretofore recognized the potential benefits to be realized by automatically detecting the arrival of a customer at a service facility, and then initiating customer service activities upon detection of the customer's arrival.

### SUMMARY OF THE INVENTION

According to an aspect of the invention, a method of communicating with a customer includes receiving a signal that indicates arrival of a customer at a service facility. The method further includes the step, performed in response to the received signal, of accessing a database to retrieve first data concerning the customer. The method further includes the step, performed on the basis of the retrieved first data, of transmitting second data to the customer.

The transmitting step may include transmitting the second data to a computing device carried by the customer. The signal indicating arrival of the customer may have been received from the computing device carried by the customer. The second data transmitted to the customer may have been included in the first data retrieved from the database.

The service facility at which the customer has arrived may be an airline terminal, and the first data retrieved from the database concerning the customer may include flight reservation information. The second data transmitted to the customer may include instructions for checking-in for a flight or a notification that the flight is delayed or canceled. The second data may further include information concerning a substitute flight and/or information concerning a hotel reservation.

A portable computing device carried by the customer, and a computer operated by a service provider, may be employed to carry out the inventive method steps described above. Computer program products may be provided in accordance with these and other aspects of the invention. The inventive program is carried by a medium readable by a computer (e.g., a carrier wave signal, a floppy disc, a hard drive, a random access memory).

As used in this specification and the accompanying claims, “service facility” means any facility in which a service is provided, including an airline terminal or other transportation terminal, a retail establishment, an entertainment venue such as a sports arena, a concert hall or a theater, a convention hall, or a government office.

With the system and method provided in accordance with the invention, customer service may be improved by commencing computer operations relative to the customer and initiating communications with the customer automatically upon the customer's arrival at a service facility. Particular gains in customer service may be realized by implementing the invention in the context of an airline terminal, at which the customer may be automatically apprised of flight delays and aided in making alternative plans to compensate for delays, without intervention by airline employees, and immediately upon the customer's arrival at the airline terminal. Furthermore, a system provided in accordance with the invention may improve the efficiency with which airline personnel provide service, by queuing and guiding customers to staffed airline service positions in accordance with priorities that optimize the overall customer service experience provided to customers in general.

Other features and advantages of the present invention will become more fully apparent from the following detailed description of the preferred embodiments, the appended claims and the accompanying drawings.

### BRIEF DESCRIPTION OF THE DRAWINGS

FIG. 1 is a schematic block diagram of computing equipment with which the present invention may be implemented; and

FIG. 2 is a flow chart that illustrates a method performed in accordance with an embodiment of the invention.

### DETAILED DESCRIPTION OF PREFERRED EMBODIMENTS

In accordance with an embodiment of the invention, a computer system operated by a service provider automatically begins customer service activities upon a customer's arrival at a service facility. The customer's arrival is detected automatically on the basis of a signal received from a device carried by the customer. Upon receipt of the signal, a database is accessed to identify the customer and to retrieve information relative to the customer. Suitable data to perform a customer service function is communicated from the service provider's computer to the device carried by the customer. The device may be, for example, a personal digital assistant (PDA) or a portable computer such as a laptop computer or a so-called “wearable” personal computer. The information transmitted to the customer's device may include information relevant to a service to be provided to the customer and/or guidance on how, when and where to receive service from an employee of the service provider. Information transmitted to the customer's computing device may also provide the customer with options for requesting or selecting additional or substitute products or services available from the service provider.

A particular embodiment of the invention will now be described in the context of a customer arriving to board a flight at an airline terminal. In general, embodiments of the invention may be employed by any service provider (e.g., a sponsor of rock concert or trade show or any public event, a retailer, a government agency).

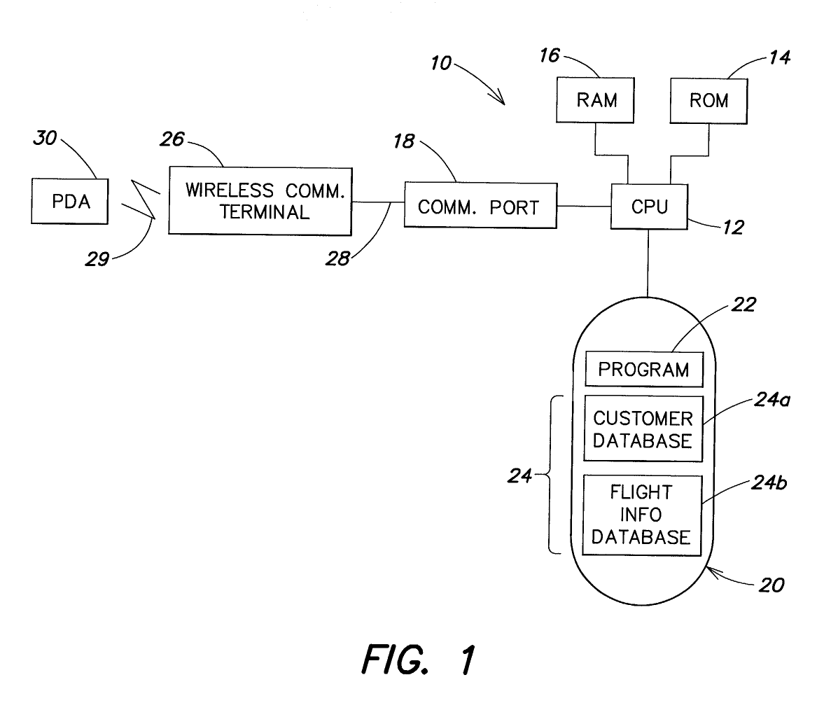

FIG. 1 is a schematic block diagram of exemplary computing equipment which may be employed to implement an embodiment of the invention. The computing equipment includes a mainframe computer 10. The mainframe computer 10 includes conventional components such as a CPU 12, a read only memory (ROM) 14 connected to CPU 12, and a random access memory (RAM) 16 connected to the CPU 12. Also included in the mainframe computer 10 is a communication port 18 connected to the CPU 12, and a mass storage device 20 (e.g., a hard disk drive) connected to the CPU 12.

Stored in the mass storage device 20 are one or more programs 22 for controlling operation of the mainframe computer 10. Also stored in the mass storage device 20 are one or more databases 24 which hold data relevant to the business of the airline which operates the mainframe computer 10. As will be seen, the databases 24 may include a customer database 24a, which stores names of customers, addresses and other contact information for the customers, one or more identifying codes for the customers, and so forth. There may also be stored in the customer database indications as to the status of each customer, i.e. indications that the customer is a preferred customer, a frequent flyer, etc.

The databases 24 may also include a flight information database 24b. The flight information database may store information indicative of flights scheduled to be operated by airlines. The flight information may indicate flight number, departure date and time, airport of departure, arrival date and time, arrival airport, and status of the flight, such as on time, delayed, canceled. The flight database may also include information indicative of reservations held by customers for the flights.

Connected to the CPU 12 via communication port 18 is a wireless communication terminal 26. The wireless communication terminal 26 may be located at the passenger terminal of the airline which operates the mainframe computer 10. It will be appreciated that the mainframe computer 10 need not be located at the passenger terminal but rather may be located virtually anywhere, and may be connected to the wireless communication terminal 26 by a suitable communication channel 28. The wireless communication terminal 26 is adapted to provide a wireless communication channel 29 to and from a portable computing device 30 carried into or near the airline passenger terminal by a customer. The portable computing device 30 may be, for example, a PDA, a “wearable” personal computer, a laptop computer, or any other device arranged to engage in wireless data communications. As another example, the portable computing device 30 may be a cellular telephone of the type adapted to receive and display digital information.

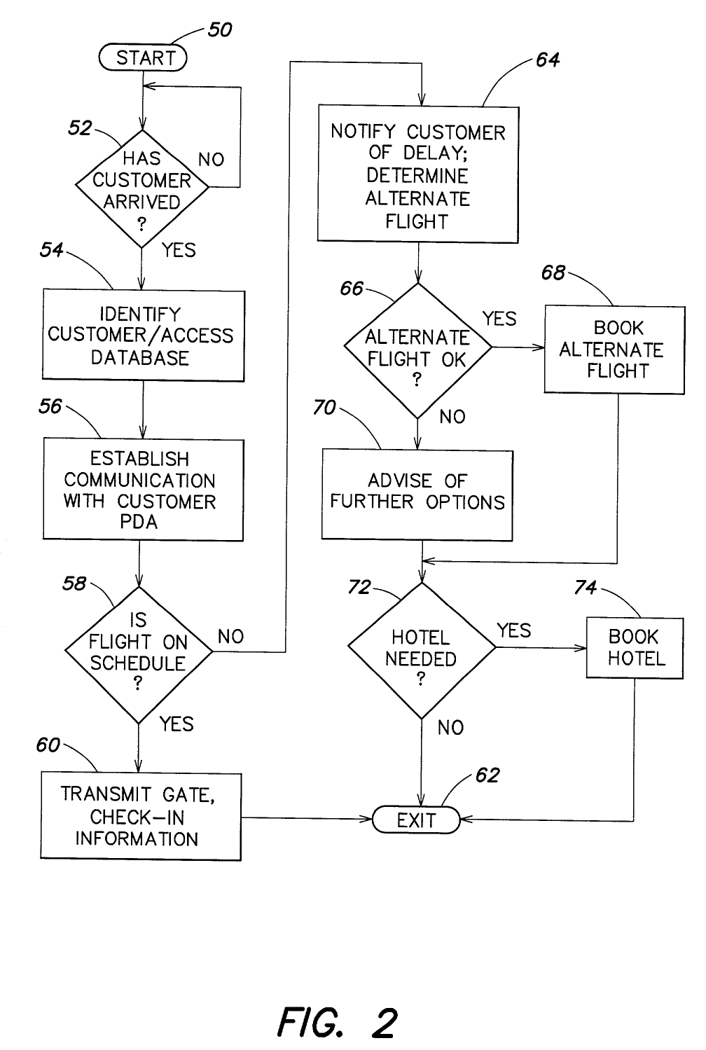

FIG. 2 is a flow chart that illustrates a process carried out in accordance with this embodiment of the invention. One or more of the steps of the process of FIG. 2 may be embodied in computer program code stored within the mainframe computer 10 (e.g., as one or more computer program products stored within one or more of the RAM 16, the ROM 14 and the mass storage device 20). The process of FIG. 2 begins with a start block, as indicated at 50 in FIG. 2. Following block 50 is block 52 at which it is determined whether a customer has arrived at the airline passenger terminal. Detection of the arrival of the customer may occur in a number of ways. For example, arrival of the customer may be detected on the basis of interaction between the portable computing device 30 and the wireless communication terminal 26. Alternatively, the customer may carry a device such as a transponder (e.g., a radio frequency identification (RFID) transponder) which may be detected by a transponder reader, which is not separately shown but which may be associated with the wireless communication terminal 26. As still another alternative, the customer may indicate his or her arrival at the airline passenger terminal by swiping a magnetic stripe card through a suitable terminal/reader, which is not separately shown but which may be associated with the wireless communication terminal 26.

Upon detection that the customer has arrived at the airline passenger terminal, block 54 follows. At block 54, the mainframe computer 10 accesses one or more databases to identify the customer and to retrieve information relevant to the customer. It is to be understood that the identification of the customer may be based on one or more codes included in a signal received from portable computing device 30 or from another device carried by the customer, such as an RFID transponder. The data retrieved with respect to the customer may include data indicating a flight reservation held by the customer for departure from the airline terminal on that day. Other data that may be retrieved may include information that indicates the status of the flight for which the customer holds a reservation. Still further information that may be retrieved relative to the customer includes departure gate information for the flight in question, check-in procedures for the flight, scheduling of check-in for the flight and so forth.

Before, during or after retrieval of the customer-relevant information, the mainframe 10 may establish communication (as represented by block 56) with the customer's portable computing device 30 via wireless communication terminal 26 and wireless communication channel 29. For example, the customer's portable computing device may be caused to display a welcoming message such as “Welcome to Big Blue Airlines”.

Following blocks 54 and 56 is a decision block 58, at which it is determined from the information retrieved at block 54 whether the customer's flight is scheduled to depart on time (or is not significantly delayed). If so, block 60 follows decision block 58. At block 60, the mainframe 10 causes one or more appropriate pieces of information to be transmitted to the customer's portable computing device 30. This information may include gate or other boarding information, check-in information, or the like. For example, the following messages may be displayed on the customer's portable computing device 30 after corresponding data has been transmitted to the portable computing device:

“Your flight no. 123 is on time.”

“Boarding will begin at 8:30 a.m. from Gate 25, Concourse B.”

“If you have baggage to check, please proceed immediately to Big Blue Service Counter Position No. 7.”

Alternative messages relating to baggage check-in might be as follows:

“If you have bags to check, please report to Big Blue Service Position No. 6 at 7:45 for baggage check-in.”

Alternatively:

“If you have bags to check, please wait in the Big Blue passenger lounge until we call you to our service counter.”

Following block 60 the process of FIG. 2 ends, as indicated at 62.

As an alternative to displaying the messages on a display of the portable computing device, the messages may be audibly reproduced by the portable computing device.

As may be inferred by the exemplary messages listed above, one application of the communication channel between the mainframe 10 and the customer's portable computing device 30 is to allow the airline to manage the flow of traffic to the airlines' service counter. Thus, customers whose flights are later in the day may be asked to wait to check baggage, thereby allowing customers whose flights are leaving sooner to have the first opportunity to check baggage.

Referring again to block 58 in FIG. 2, if the customer's flight is significantly delayed (e.g., by a delay specified in a customer profile) or canceled, then block 64 follows block 58. At block 64, data is transmitted from the mainframe 10 to the customer's portable computing device 30 to notify the customer of the delay or cancellation of the customer's flight; and the mainframe 10 may determine one or more alternative flights for the customer. Information indicative of the alternative flight or flights may also be transmitted from the mainframe 10 to the customer's portable computing device 30. The customer may be prompted to indicate whether he or she approves of the alternate flight proposed by the mainframe 10. The customer's indication of approval or non-approval of the alternate flight may be communicated from the portable computing device 30 to the mainframe 10 via the wireless communication channel 29, the wireless communication terminal 26, and the communication channel 28.

Following block 64 is a decision block 66. If it is determined at block 66 that the customer has approved the alternate flight, then a reservation is made in the customer's name for the alternate flight, and other suitable data entries are made in the databases 24, as indicated at block 68. The customer may also be provided with instructions via wireless communication terminal 26, wireless communication channel 29 and the customer portable computing device 30 relating to the alternative flight. E.g., “You have been booked onto Big Red flight no 456, departing in 45 minutes. Please proceed to the Big Red Airways terminal to check-in for your alternate flight.”

If at block 66 it is determined that the customer did not approve the alternate flight, then block 70 follows block 66. At block 70 the mainframe 10 may inform the customer of further options. For example, if the flight is only delayed, the following message may be transmitted to the customer's portable computing device 30:

“Boarding will commence at Gate 25 in 2 hours.”

Alternatively, the following message may be transmitted to the customer's portable computing device 30:

“Please proceed to the service counter for assistance in making alternate arrangements.”

Following block 70 or block 68, as the case may be, is a decision block 72, at which it is determined whether the customer will need a hotel reservation. For example, if the alternate flight that has been booked at block 68 is scheduled to depart the next day, the mainframe 10 may automatically determine that a hotel reservation for the customer is needed. In this case, as indicated at block 74, the mainframe 10 automatically proceeds to book a hotel reservation for the customer (e.g., by communicating with a reservation computer of a hotel chain). Then, a message like the following may be transmitted to the customer's portable computing device 30:

“Big Blue Airlines has booked a room for you at the airport hotel. Please proceed to the hotel to check into your room.”

For purposes of illustration, the process of FIG. 2 is shown as ending at 62 after block 72 or block 74, as the case may be. However, it should be recognized that communication with the customer's portable computing device may continue, as required, until the customer has boarded his or her flight or at some other time thereafter.

From the foregoing, it will be noted that at least one embodiment of the present invention calls for opening up a communication channel with a customer upon the customer's arrival at a service facility. By doing so, the arrangement of the present invention makes it possible for automated equipment to greet the customer, guide the customer to available services, inform the customer of problems, and solve the problems. As a result, customer service is improved, the burdens on the customer service staff are reduced, and customer satisfaction is enhanced.

The foregoing description discloses only preferred embodiments of the invention; modifications of the above disclosed apparatus and methods which fall within the scope of the invention will be readily apparent to those of ordinary skill in the art. For example, the device carried by the customer with which the mainframe communicates may be an intelligent cellular telephone, and communications between the mainframe and the cellular telephone may be via telephone calls routed through a cellular telephone network. Any suitably programmed conventional computing device may be employed in place of the mainframe computer 10 (e.g., a personal computer, a laptop computer, etc.).

Accordingly, while the present invention has been disclosed in connection with preferred embodiments thereof, it should be understood that other embodiments may fall within the spirit and scope of the invention as defined by the following claims.

The invention claimed is:

1. A method of communicating with a customer, comprising:
receiving a signal that indicates arrival of a customer at a service facility;
in response to the received signal, accessing a database to retrieve first data concerning the customer; and
on the basis of the retrieved first data, transmitting second data to the customer.

2. The method of claim 1, wherein the transmitting step includes transmitting the second data to a computing device carried by the customer.

3. The method of claim 2, wherein the signal is received from the computing device carried by the customer.

4. The method of claim 1, wherein the signal is received from a device carried by the customer.

5. The method of claim 4, wherein the device carried by the customer is a computing device.

6. The method of claim 1, wherein the first data includes the second data.

7. The method of claim 1, wherein the service facility is an airline terminal.

8. The method of claim 7, wherein the first data includes flight reservation information.

9. The method of claim 7, wherein the second data includes instructions for checking-in for a flight.

10. The method of claim 7, wherein the second data includes a notification that a flight is delayed or canceled.

11. The method of claim 10, wherein the second data includes information concerning a substitute flight.

12. The method of claim 10, wherein the second data includes information concerning a hotel reservation.

13. A system for providing communication between a customer and a service provider, comprising:
a portable computing device carried by the customer; and
a computer operated by the service provider and programmed to:
receive a signal that indicates that the customer has arrived at a service facility;
in response to the received signal, access a database to retrieve first data concerning the customer; and
on the basis of the retrieved first data, transmit second data to the portable computing device carried by the customer.

14. The system of claim 13, wherein the signal is transmitted from the portable computing device carried by the customer.

15. The system of claim 13, wherein the portable computing device is a personal digital assistant (PDA).

16. The system of claim 13, wherein the first data includes the second data.

17. The system of claim 13, wherein the service facility is an airline terminal.

18. The system of claim 17, wherein the first data includes flight reservation information.

19. The system of claim 17, wherein the second data includes instructions for checking-in for a flight.

20. The system of claim 17, wherein the second data includes a notification that a flight is delayed or canceled.

21. The system of claim 20, wherein the second data includes information concerning a substitute flight.

22. The system of claim 21, wherein the second data includes information concerning a hotel reservation.

23. A method of communicating with a customer, comprising:
automatically detecting arrival of a customer at a service facility;
identifying the customer;
retrieving information related to the customer from a database; and
transmitting a message to the customer via a computing device carried by the customer.

24. The method of claim 23, wherein the computing device is a personal digital assistant (PDA).

25. The method of claim 23, wherein the computing device is a cellular telephone.

26. A method of communicating with a customer at an airline terminal, comprising:
receiving a signal that indicates arrival of the customer at the airline terminal; and
in response to receipt of the signal, transmitting data via a wireless communication channel to a portable computing device carried by the customer.

27. The method of claim 26, further comprising displaying the transmitted data via a display device that is part of the portable computing device.

28. The method of claim 26, further comprising retrieving the data from a database prior to the transmitting step.

29. The method of claim 26, further comprising identifying the customer on the basis of the received signal.

30. The method of claim 26, further comprising determining whether the customer's flight is on time, the transmitted data indicating a result of the determining step.

31. The method of claim 30, further comprising presenting an alternative flight to the customer if it is determined that the customer's flight is not on time.

32. The method of claim 30, further comprising booking a hotel room for the customer if it is determined that the customer's flight is not on time.

33. A computer program product comprising:
a medium readable by a computer, the computer readable medium having computer program code adapted to:
receive a signal that indicates arrival of a customer at a service facility;
in response to the received signal, access a database to retrieve first data concerning the customer; and
on the basis of the retrieved first data, transmit second data to the customer.

34. A computer program product comprising:
a medium readable by a computer, the computer readable medium having computer program code adapted to:
automatically detect arrival of a customer at a service facility;
identify the customer;
retrieve information related to the customer from a database; and
transmit a message to the customer via a computing device carried by the customer.

35. A computer program product comprising:
a medium readable by a computer, the computer readable medium having computer program code adapted to:
receive a signal that indicates arrival of a customer at an airline terminal; and
in response to receipt of the signal, transmit data via a wireless communication channel to a portable computing device carried by the customer.
